(19) United States
(12) Patent Application Publication
(10) Pub. No.: US 2019/0104500 A1
(43) Pub. Date: Apr. 4, 2019

(54) Efficient Paging Configuration

(71) Applicant: Telefonaktiebolaget LM Ericsson (publ), Stockholm (SE)

(72) Inventors: Andres Reial, Malmö (SE); Asbjörn Grövlen, Stockholm (SE)

(21) Appl. No.: 16/192,141

(22) Filed: Nov. 15, 2018

Related U.S. Application Data
(63) Continuation of application No. PCT/EP2018/076627, filed on Oct. 1, 2018.
(60) Provisional application No. 62/566,777, filed on Oct. 2, 2017.

(51) Int. Cl. H04W 68/02; H04L 5/00; G06F 9/455

(52) U.S. Cl. CPC H04W 68/02; H04L 5/0053; G06F 2009/45591; G06F 9/45558; G06F 2009/45595; H04L 5/0078

(57) ABSTRACT

According to embodiments described herein, a method, performed by a wireless device, of adopting parameters for communication with a wireless communication network is disclosed. The method comprises receiving information broadcast by a base station of the network and obtaining, from the broadcast information, a Remaining Minimum System Information (RMSI) transmission parameter configuration. The method further comprises receiving a RMSI transmission from the base station according to the RMSI transmission parameter. If a paging transmission parameter configuration is included in the received RMSI, the method comprises adopting the paging transmission parameter configuration for paging reception. If the paging transmission parameter configuration is not included in the received RMSI, the method comprises adopting the RMSI transmission parameter configuration for paging reception.

This application is a continuation of International Application PCT/EP2018/076627, having an international filing date of 1 Oct. 2018, which claims the benefit of U.S. Provisional Application No. 62/566,777, filed 2 Oct. 2017, the disclosure of all of which are incorporated herein by reference in their entirety.

### BACKGROUND

Wireless communication networks, enabling voice and data communications to mobile devices, are ubuquituous in many parts of the world, and continue to advance in technological sophistication, system capacity, data rates, bandwidth, supported services, and the like. A basic model of one type of wireless networks, generally known as “cellular,” features a plurality of fixed network nodes (known variously as base station, radio base station, base transceiver station, serving node, NodeB, eNobeB, eNB, gNB, and the like), each providing wireless communication service to a large plurality of mobile devices (known variously as mobile terminals, User Equipment or UE, and the like) within a generally fixed geographical area, known as a cell or sector. Cellular networks have a natural division between the “core” network, generally comprising fixed nodes, and the Radio Access Network (RAN), by which mobile devices connect to, and move between, serving nodes of the core network.

To establish a service connection to the network, such as upon powering up, a mobile device engages in a Random Access (RA) procedure. Conversely, when the network has a service or data to deliver to a mobile device, it engages in a paging procedure to locate the desired device.

Long Term Evolution (LTE) is a sophisticated, 4th generation (4G) wireless communication network protocol promulgated by the Third Generation Partnership Project (3GPP). The primary LTE RAN is the Evolved Universal Mobile Telecommunications System (UMTS) Terrestrial RAN, or E-UTRAN. LTE E-UTRAN is a single numerology system, with a fixed carrier spacing of 15 kHz.

New Radio (NR) is the 5th generation (5G) protocol being defined by 3GPP. NR is designed to support many different use cases, including:
Enhanced Mobile Broadband (eMBB), requiring very high data rates and large bandwidths;
Ultra Reliable Low Latency Communications (URLLC) requiring very low latency, very high reliability and availability; and
Massive Machine Type Communications (mMTC), requiring low bandwidth, high connection density, enhanced coverage, and low energy consumption at the user end.

To provide the flexibility to support many different use cases, NR features a flexible numerology. For example, the LTE 15 kHz subcarrier spacing may be expanded in multiples of 2. This flexibility is important, as NR is designed to include numerous features, the implementation of which have a implications for the NR waveform and numerology. These include:
Support for a wide range of frequencies, bandwidths, and deployment options. As mentioned above, NR should support diverse use cases such as eMBB, URLLC, and mMTC.
Support for applications with very low latency, which requires very short subframes.
Support for both access and backhaul links by dynamically sharing the spectrum. NR should also support Device-to-Device (D2D) communication, including Vehicle-to-Anything (V2X) communication, as well as the conventional uplink (UL) and downlink (DL) signaling.
Enable the full potential of Multi-antenna technology. The number of antenna elements may vary, from a relatively small number of antenna elements in LTE-like deployments to many hundreds, where a large number of active or individually steerable antenna elements are used for beamforming, single-user MIMO (SU-MIMO) and multi-user MIMO (MU-MIMO).
NR is envisioned to be based on mainly Time Division Duplex (TDD) at high frequencies (above 3 GHz) and mainly Frequency Division Duplex (FDD) in lower frequencies. Flexibility will thus be required for efficient time/frequency utilization for the respective FDD and TDD deployments.

### Signaling Numerologies and SCS

In general, signalling numerology, or simply numerology, refers to the combination of subcarrier spacing (SCS), OFDM symbol length, cyclic prefix (CP) length, etc. used for signal transmission. In NR, multiple numerologies (for SCS=15*2n kHz for n=0 . . . 5) have been defined by 3GPP, each with associated additional signal parameters. The 2n construction allows simultaneous transmission of signals with different SCS in the same carrier during the same OFDM symbol. In some deployments, different NR signals may use different numerologies to ensure appropriate tradeoff between coverage (lower SCS are more robust to dispersion and allow better coverage) and data capacity (higher SCS are more robust to e.g. phase noise).

### CORESET

CORESET, or control resource set, is the time/frequency (T/F) location (and possibly size) of a downlink (DL) control channel (e.g. physical downlink control channel, PDCCH) transmissions. The transmissions can occur at one or more predetermined possible T/F locations, and the CORESET can refer to a set of multiple such locations. In NR, it is indicated e.g. for remaining minimum system information (RMSI) via a 3-bit configuration, i.e. one of 7 possible T/F locations or location sets. (The index 0 indicates no RMSI.). It thus indicates the time and frequency resources used for the NR-PDCCH and providing guidance to the wireless device, e.g. the UE, where it should search for the NR-PDCCH.

NR System Signals and SI Distribution

In NR, system access is performed by the UE by first receiving a synchronization signal (SS) block containing primary SS (PSS) and secondary SS (SSS) encoding the cell identity (ID) (eg. physical cell identity, PCI) and physical broadcast channel (PBCH) containing master information block (MIB) information. MIB contains critical system information (SI) and a CORESET pointer to the RMSI T/F location in relation to the SSB T/F location. The PBCH also informs the UE about the RMSI numerology.

An example of SSB and RMSI transmission is shown in FIG. 1. In this example deployment, the UE receives at least one SS Block (SSB) and at least one redundancy version (RV) of NR-physical downlink shared channel (NR-PDSCH), carrying the remaining minimum system information, every 20 ms while the transmission time interval (TTI) of the NR-PDSCH transport channel is 80 ms.

RMSI Configuration

The NR-PDSCH carrying the RMSI will have variable payload and has been agreed to be scheduled using the NR-PDCCH.

The configuration of the field nrPdcchSib1 in NR-PBCH is proposed to contain at least:
RMSI quasi-co-location (QCL)-indication (1 bits): In some deployments, the transmission of RMSI may not be spatially QCL with the transmission of the SS Block. For example, we may transmit the RMSI in a wide sector antenna beam while the SS Blocks are transmitted in more narrow beams. We may also provide the RMSI from a micro node while micro nodes within the coverage area of the macro node only transmit the SS Block. If the RMSI transmission is QCL with the SS Block then the UE can assume that the RX beamforming weights, automatic gain control (AGC) settings, and synchronization used for reception of the SS Block is also suitable for reception of the RMSI. When the RMSI is not QCL with the SS Block, the UE can assume that the NR-PDCCH transmission providing the RMSI (NR-SIB1) is assisted by an additional synchronization signal. For more details, see the 3GPP standardization submission document R1-1716150 “Remaining issues in NR-PBCH” Ericsson, RAN1 NR Ad-Hoc#3, Nagoya, Japan, 18th-21^{st} September 2017.
Numerology indication (2 bits): Indicates the numerology of the RMSI transmission.
CORESET configuration (3 bits): Indicates the time and frequency resources used for the NR-PDCCH. This allows for providing some assistance for the UE to guide it where it should search for the NR-PDCCH that will schedule the RMSI (NR-SIB1). With 3 bits CORESET configuration we can e.g. configure 1 out of 7 pre-defined CORESET alternatives and reserve the last code-point to a NULL configuration to be used when no RMSI is transmitted.

Pacing

Paging is used to alert one or more UEs in inactive/idle mode to contact the network e.g., for data reception, for emergency message distribution, for indicating SI updates, and the like. In NR, paging consists of paging downlink control indicator (DCI) transmission (in PDCCH) followed by a paging message (in PDSCH). The UE is configured to periodically check for paging messages, according to a discontinuous reception (DRX) and paging occasion (PO) schedule provided by the network (NW). It is given a CORESET to monitor for paging DCI transmissions in the PDCCH. In NR 3GPP RAN1 it has been discussed that the numerology and/or CORESET for paging PDCCH be either the same as RMSI, or it could be provided in SIB1 in the RMSI. The search space of NR-PDCCH addressing the paging message can be configured by the gNB (the NR base station).

### SUMMARY

According to embodiments described herein, a method, performed by a wireless device, of adopting parameters for communication with a wireless communication network is disclosed. The method comprises receiving information broadcast by a base station of the network and obtaining, from the broadcast information, a Remaining Minimum System Information (RMSI) transmission parameter configuration. The method further comprises receiving a RMSI transmission from the base station according to the RMSI transmission parameter. If a paging transmission parameter configuration is included in the received RMSI, the method comprises adopting the paging transmission parameter configuration for paging reception. If the paging transmission parameter configuration is not included in the received RMSI, the method comprises adopting the RMSI transmission parameter configuration for paging reception.

According to embodiments described herein, a method performed by a base station operative in a wireless communication network, of selectively transmitting paging configuration parameters, is disclosed. The method comprises determining a first configuration for a transmission parameter to be used for a Remaining Minimum System Information (RMSI) transmission and broadcasting the first configuration for the transmission parameter. The method further comprises determining a second configuration for the transmission parameter to be used for a paging transmission. If the second configuration differs from the first configuration, the method comprises including the second configuration in the RMSI and transmitting the RMSI including the second configuration.

According to other embodiments, there are corresponding wireless devices, user equipment, base stations, computer programs, carriers, communication systems disclosed.

### BRIEF DESCRIPTION OF THE DRAWINGS

For a more complete understanding of the embodiments and their features and advantages, reference is now made to the following description, taken in conjunction with the accompanying drawings, in which:

FIG. 1 illustrates SSB and RMSI transmission;

FIG. 2 illustrates a method performed by a wireless device communicating with a wireless communication network according to certain embodiments;

FIG. 3 illustrates a method of selectively transmitting paging configuration parameters performed by a base station according to certain embodiments;

FIG. 4 illustrates a wireless device as implemented in accordance with one or more embodiments;

FIG. 5 illustrates a schematic block diagram of an wireless device in a wireless network according to still other embodiments;

FIG. 6 illustrates a network node as implemented in accordance with one or more embodiments;

FIG. 7 illustrates a schematic block diagram of an network node in a wireless network according to still other embodiments;

FIG. 8 illustrates a wireless network;

FIG. 9 illustrates one embodiment of a UE in accordance with one or more embodiments;

FIG. 10 is a schematic block diagram illustrating a virtualization environment in which functions implemented by some embodiments may be virtualized;

FIG. 11 illustrates a telecommunication network connected via an intermediate network to a host computer in accordance with some embodiments;

FIG. 12 illustrates host computer communicating via a base station with a user equipment over a partially wireless connection in accordance with some embodiments; and

FIGS. 13-16 are flowcharts illustrating methods implemented in a communication system, in accordance with one or more embodiments.

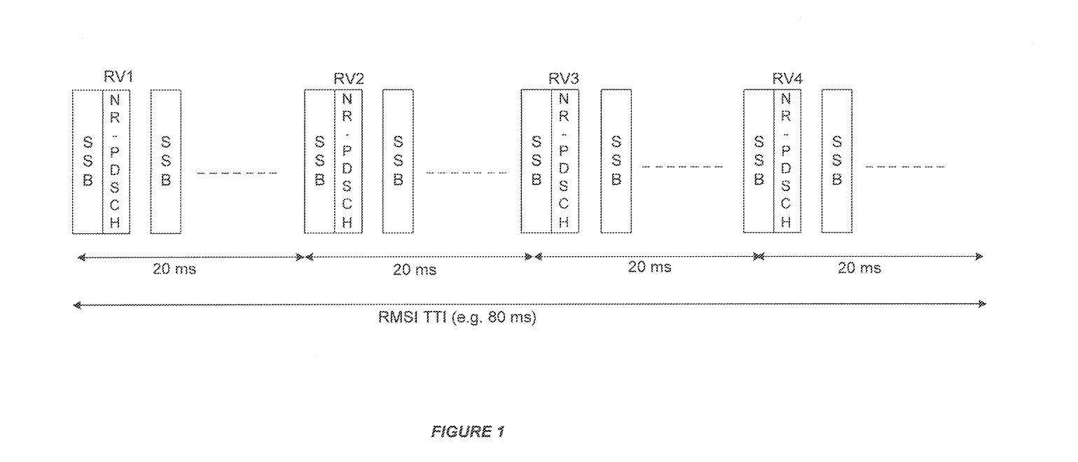

### DETAILED DESCRIPTION

There exist certain challenge(s) resulting in undesired limitations how the network can configure paging transmission. For example, if paging configuration parameters for numerology and/or CORESET are forced to be same as that for RMSI transmission, this imposes significant constraints in advanced deployments with special SI and paging coverage requirements. In practice, it may limit the ability of operators to maximize their network capacity or cost efficiency for data transmissions because of SI or paging coverage limits. Accordingly, it is important that NR reserve the ability for the configuration of transmission parameters, such as numerology and/or CORESET, to be different for RMSI transmission and for paging signalling.

On the other hand, if the paging configuration parameters are required to be transmitted in the SIB1 in cases where the RMSI and paging transmissions share the same parameters, this results in duplication of information and wasting expensive broadcast resources in many common deployments.

There is thus a need for a paging configuration approach that avoids unnecessary broadcasting operations while supporting flexible SI and paging transmission in advanced network deployments.

Certain aspects of the present disclosure and their embodiments may provide solutions to these or other challenges.

According to one more more embodiments described herein, the network transmits, e.g., numerology and/or CORESET configuration for paging in system information block 1 (SIB1) (of the RMSI) only if it differs from RMSI transmission configuration previously provided in MIB (of the PBCH). If the configurations are the same, the information is omitted in SIB1.

In another embodiment, a flag in SIB1 may explicitly indicate that the wireless device should use RMSI transmission parameter configurations also for paging signalling.

According to one more embodiments, the UE receives, in MIB (of the PBCH), transmission parameters for receiving the RMSI. Upon actually receiving the RMSI, the UE checks if paging transmission parameter configuration is provided in SIB1. If it is, the configuration information in SIB1 is used for paging signal reception. If not, the UE uses the RMSI transmission parameter configuration from MIB for paging reception. In some embodiments, the UE may retrieve a flag from SIB1 explicitly indicating that it should use the RMSI transmission parameter configuration(s) also for paging signalling. The search space of NR-PDCCH addressing the paging message can be configured by the gNB (the NR base station).

Certain embodiments may provide the technical advantage of providing the UE with a paging transmission parameter configuration when it differs from RMSI transmission parameter configuration, providing flexibility to the network to dynamically change, e.g., numerology and/or CORESET. However, if the paging transmission parameter configurations have not changed from the previously-broadcast RMSI transmission parameter configuration, valuable air interface resources are not wasted with unnecessary overhead transmissions.

In view of the embodiments above, the present disclosure generally includes the following embodiments, e.g., which may address one or more of the issues disclosed herein. Note that although the terminology used to describe embodiments of the invention has been aligned with 3GPP NR RAN1-2 agreements, the principles of embodiments of the invention may be applicable to other radio access technologies (RATs) and cellular network implementations.

The options for paging numerology and CORESET are to use the same paging parameters as indicated for RMSI in the PBCH or to specify them in the RMSI. There is a wide range of foreseeable NR deployments, including co-existence needs with LTE in some cases and different coverage requirements for different signals in the NR NW. The paging signals are furthermore not necessarily transmitted from the same transmission points (TRPs) and with the same period as the RMSI. Therefore, requiring that paging transmission be limited to the same numerology and CORESET as the RMSI is likely to be limiting for efficient network configuration in many deployments. Advantageously, the paging signal parameters are separately configurable in RMSI. However, it may be adopted as a default assumption that, in the absence of paging numerology and CORESET configuration info in the RMSI, the respective RMSI parameters apply.

The present disclosure hence describes a paging numerology and CORESET that are configurable in RMSI. In the absence of paging numerology and CORESET configuration information in the RMSI, the respective parameters indicated for RMSI in PBCH apply.

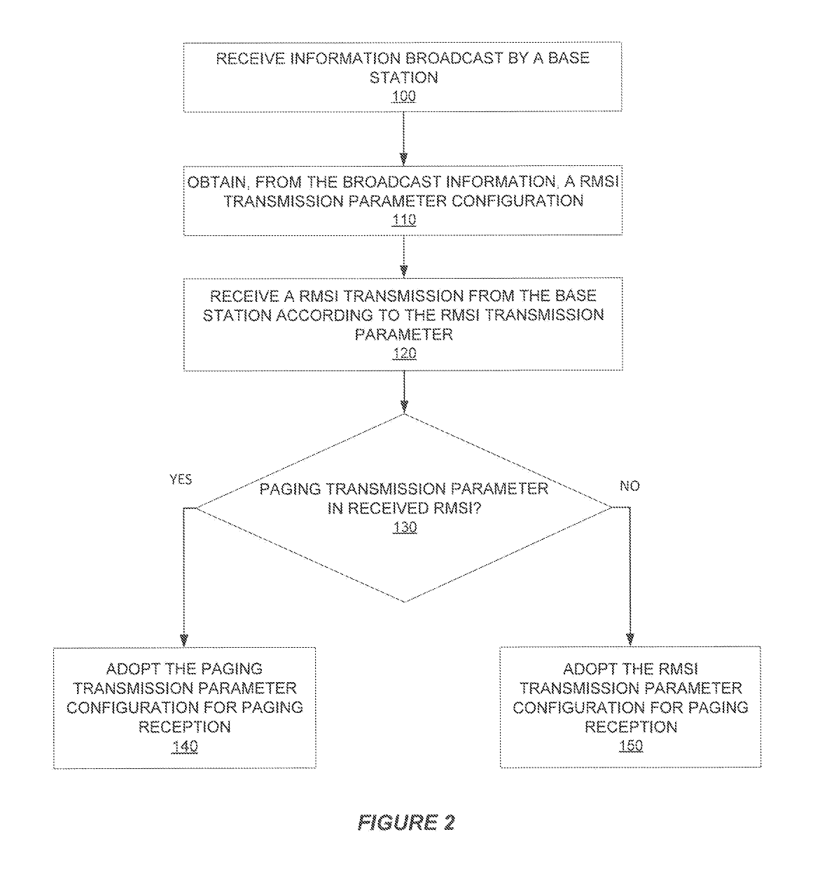

FIG. 2 depicts a method in accordance with particular embodiments. The method is performed by a wireless device (e.g., UE), and is a method of communicating with a wireless communication network. The method in FIG. 2 includes receiving information broadcast by a base station of the network (block 100) and obtaining, from the broadcast information, a RMSI transmission parameter configuration (block 110). The broadcast information may be received in a physical broadcast channel (PBCH), and the RMSI transmission parameter configuration may be retrieved from a master information block (MIB) in the broadcast. The RMSI transmission parameter may comprise, e.g., numerology or CORESET.

The method in FIG. 2 further includes receiving a RMSI transmission from the base station according to the RMSI transmission parameter (block 120), and inspecting or determining from the received RMSI for a paging transmission parameter configuration (130). The RMSI transmission may be received on a physical downlink shared channel (PDSCH), and the paging transmission parameter configuration may be included in a first system information block (SIB1) of the RMSI.

If a paging transmission parameter configuration is included in the received RMSI (block 130), the wireless device adopts the paging transmission parameter configuration for paging reception (block 140).

On the other hand, if the paging transmission parameter configuration is not included in the received RMSI (block 130), the wireless device adopts the RMSI transmission parameter configuration for paging reception (block 150). The wireless device then receives paging signals from the base station, which are transmitted according to the transmission parameter configuration adopted for paging reception. In this manner, the wireless device is provided a transmission parameter configuration for the paging only if necessary to properly receive the paging signals. If the paging is transmitted using the same transmission parameter configuration as was the RMSI, then system overhead is not wasted in providing the wireless device with the same configuration multiple times.

In some embodiments, not shown in FIG. 2, rather than rely in the absence of a paging transmission parameter configuration in the RMSI, the wireless device may retrieve a flag from the RMSI explicitly indicating that the RMSI transmission parameter configuration should also be used for paging signalling.

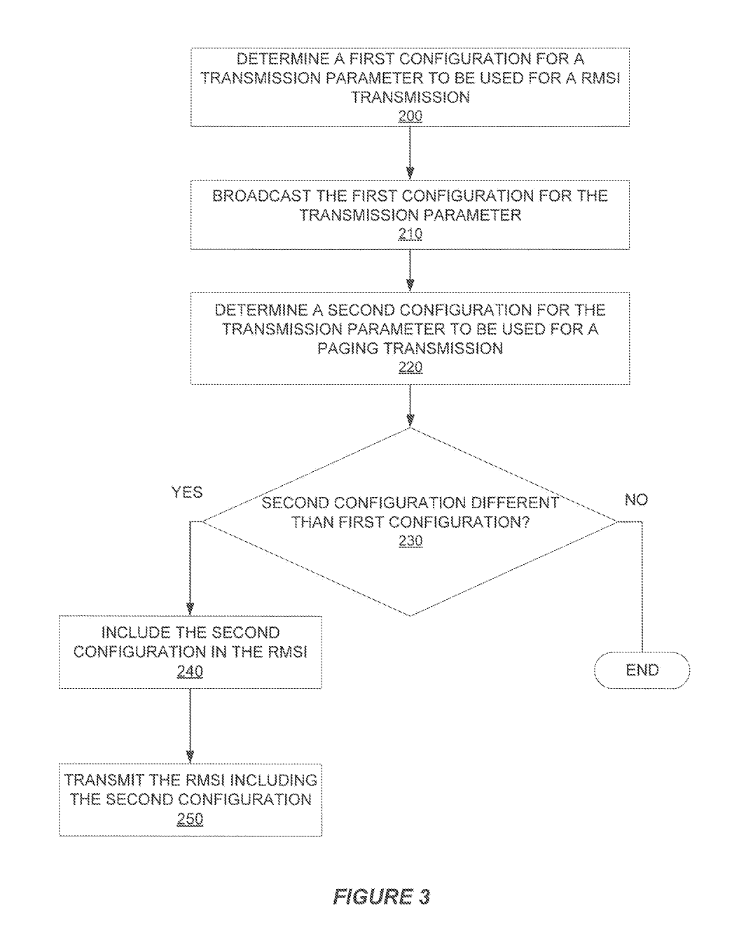

FIG. 3 depicts a method in accordance with other particular embodiments. The method in FIG. 3 is performed by a base station (e.g., a eNB or gNB) operative in a wireless communication network, and is a method of selectively transmitting paging configuration parameters. The method in FIG. 3 includes determining a first configuration for a transmission parameter to be used for a RMSI transmission (block 200), and broadcasting the first configuration for the transmission parameter (block 210). The first configuration for the transmission parameter may be included in a master information block (MIB), and the MIB may be broadcast on physical broadcast channel (PBCH). The transmission parameter may comprise, e.g., numerology and/or CORESET. The transmission parameter configuration may be based on coverage requirements (e.g., lower numerologies provide larger coverage), co-existence requirements (e.g., 15 kHz SCS is easier to accommodate with an existing LTE deployment), network load (e.g., a RMSI CORESET with multiple search options offers increased flexibility for scheduling RMSI without interfering with data transmission), or the like.

The method 2 further includes determining a second configuration for the transmission parameter to be used for a paging transmission (block 220). The second configuration for the transmission parameter may be based on selected paging area configurations and the corresponding coverage requirements (e.g., lower numerologies provide larger coverage), co-existence requirements (e.g., 15 kHz SCS is easier to accommodate with an existing LTE deployment), network load (e.g. a paging CORESET that differs from the RMSI CORESET offers increased flexibility for paging scheduling), or the like.

Only if the second configuration differs from the first configuration (block 230), the second configuration is included in the RMSI (block 240), and the RMSI is transmitted to a wireless device (block 250). The first configuration and the second configuration may be different depending on difference in network load criteria, for example the NW data load may be sufficiently high so that a single RMSI PDCCH location may be configured, while the paging load variations may be significant enough so that, over time, different numbers of paging PDCCH locations may need to be indicated—a single T/F location overlapping with the RMSI T/F locations when a small number of UEs are in the inactive/idle state, or multiple locations when many UEs are in these states. Similarly, there may be a difference in RMSI and paging coverage requirements, since the RMSI coverage area (a set of SSB beams or transmission points (TRPs) in a cell) and the paging coverage area (a different multiple SSB beams, TRPs or cells) may not be the same.

The second configuration for the transmission parameter may be included in a first system information block (SIB1) of the RMSI, and the RMSI may be transmitted on a physical downlink shared channel (PDSCH). On the other hand, if the second configuration for the transmission parameter is the same as the first configuration for the transmission parameter (block 230), then the method ends, and no further transmission parameter configuration needs to be transmitted, as the wireless device may simply continue to use the first transmission parameter configuration, which was broadcast at block 210. Hence, the method in FIG. 3 enables the base station to update a transmission parameter configuration if necessary for a UE to receive paging signals, but saves overhead if the same transmission parameter configuration is used for paging as was used for RMSI transmission.

In some embodiments, not shown in FIG. 3, if the second configuration is the same as the first configuration, rather than simply ending the method in FIG. 3, the base station may include a flag in the RMSI that explicitly informs the wireless device that the first transmission parameter configuration (received in broadcast) should also be used for paging signalling.

Note that the apparatuses or devices described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

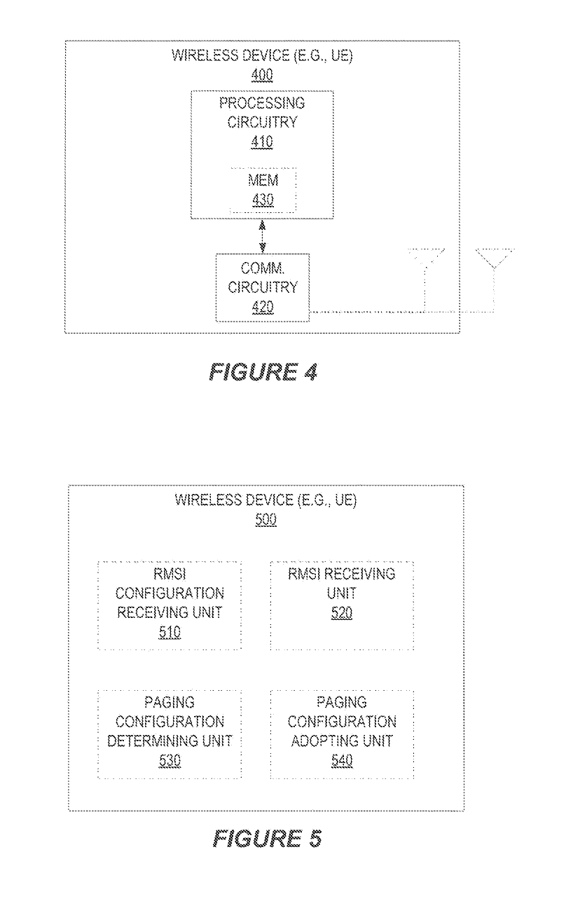

FIG. 4 for example illustrates a wireless device 400 as implemented in accordance with one or more embodiments. As shown, the wireless device 400 includes processing circuitry 410 and communication circuitry 420. The communication circuitry 420 (e.g., radio circuitry) is configured to transmit and/or receive information to and/or from one or more other nodes, e.g., via any communication technology. Such communication may occur via one or more antennas that are either internal or external to the wireless device 400. The processing circuitry 410 is configured to perform processing described above, such as by executing instructions stored in memory 430. The processing circuitry 410 in this regard may implement certain functional means, units, or modules.

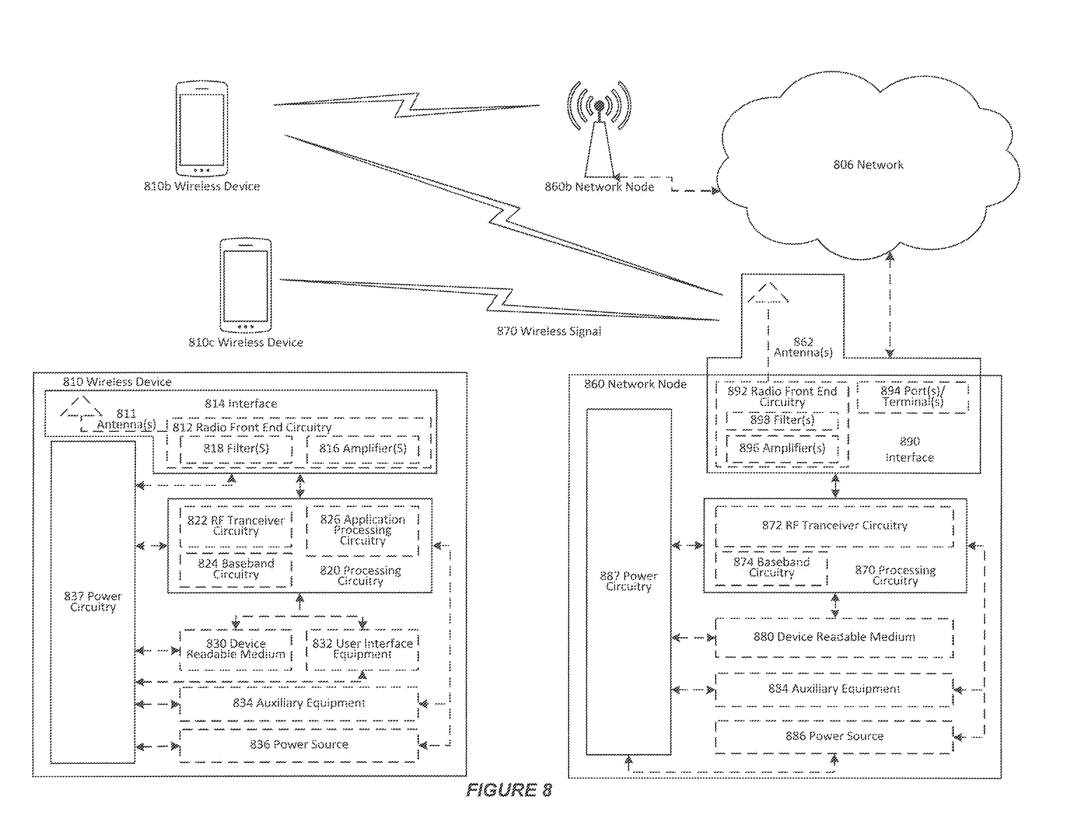

FIG. 5 illustrates a schematic block diagram of an wireless device 500 in a wireless network according to still other embodiments (for example, the wireless network shown in FIG. 8). As shown, the wireless device 500 implements various functional means, units, or modules, e.g., via the processing circuitry 410 in FIG. 4 and/or via software code. These functional means, units, or modules, e.g., for implementing the method in FIG. 2 described herein, include for instance: RMSI configuration receiving unit 510, RMSI receiving unit 520, paging configuration determining unit 530, and paging configuration adopting unit 540. RMSI configuration receiving unit 510 is configured to receive information broadcasted by a base station of the network and obtain, from the broadcast information, a RMSI transmission parameter configuration. RMSI receiving unit 520 is configured to receive a RMSI transmission from the base station according to the RMSI transmission parameter. Paging configuration determining unit 530 is configured to inspect the received RMSI for a paging transmission parameter configuration, and determine whether or not a paging transmission parameter configuration (different from the RMSI transmission parameter configuration) should be adopted for receiving paging signals. Paging configuration adopting unit 540 is configured to adopt the paging transmission parameter configuration determined by the paging configuration determining unit 530.

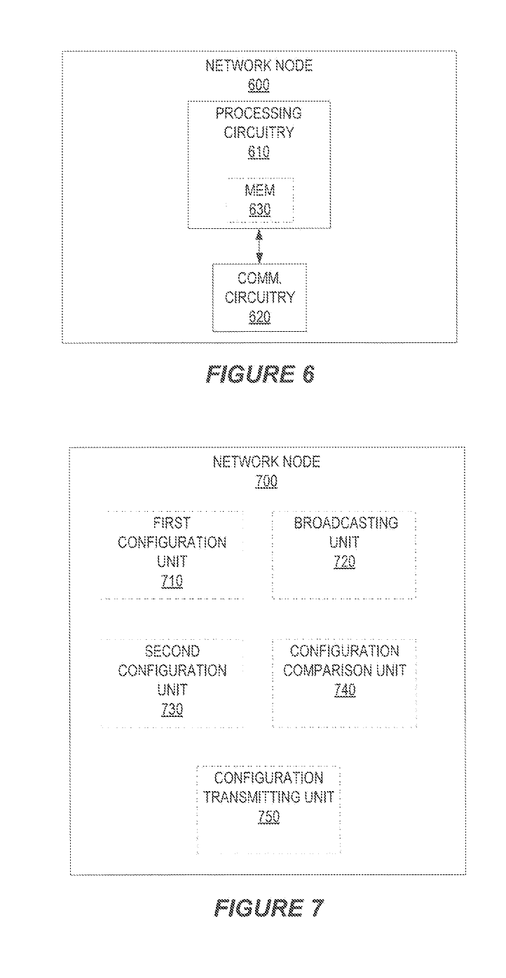

FIG. 6 illustrates a network node 600 as implemented in accordance with one or more embodiments. As shown, the network node 600 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, such as by executing instructions stored in memory 630. The processing circuitry 610 in this regard may implement certain functional means, units, or modules.

FIG. 7 illustrates a schematic block diagram of an network node 700 in a wireless network according to still other embodiments (for example, the wireless network shown in FIG. 8). As shown, the network node 700 implements various functional means, units, or modules, e.g., via the processing circuitry 610 in FIG. 6 and/or via software code. These functional means, units, or modules, e.g., for implementing the method 2 described herein, include for instance: first configuration unit 710, broadcasting unit 720, second configuration unit 730, configuration comparison unit 740, and configuration transmitting unit 750. First configuration unit 710 is configured to determine a first configuration for a transmission parameter to be used for a RMSI transmission. Broadcasting unit 720 is configured to broadcast the first configuration for the transmission parameter. Second configuration unit 730 is configured to determine a second configuration for the transmission parameter to be used for a paging transmission. Configuration comparison unit 740 is configured to determine whether the second configuration differs from the first configuration. If so, the configuration transmitting unit 750 is configured to include the second configuration in the RMSI and transmit the RMSI to a wireless device.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 806, network nodes 860 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), NR and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or Zig Bee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and a RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, WCDMA, LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SOC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units

In certain embodiments, some or all of the functionality described herein as being provided by a network node, base station, eNB or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data or information, including a computer program, software, an application including one or more of logic, rules, code, tables, etc. and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated.

Interface 890 is used in the wired or wireless communication of signalling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862. Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872, as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 890 and may be any type of antenna capable of transmitting and receiving data and/or signals wirelessly. In some embodiments, antenna 862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data and/or signals may be received from a wireless device, another network node and/or any other network equipment. Similarly, antenna 862, interface 890, and/or processing circuitry 870 may be configured to perform any transmitting operations described herein as being performed by a network node. Any information, data and/or signals may be transmitted to a wireless device, another network node and/or any other network equipment.

Power circuitry 887 may comprise, or be coupled to, power management circuitry and is configured to supply the components of network node 860 with power for performing the functionality described herein. Power circuitry 887 may receive power from power source 886. Power source 886 and/or power circuitry 887 may be configured to provide power to the various components of network node 860 in a form suitable for the respective components (e.g., at a voltage and current level needed for each respective component). Power source 886 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-loT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836 and power circuitry 837. WD 810 may include multiple sets of one or more of the illustrated components for different wireless technologies supported by WD 810, such as, for example, GSM, WCDMA, LTE, NR, WiFi, WiMAX, NB-loT, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 820 may be configured to perform any receiving or transmitting operations described herein as being performed by a WD. Any information, data and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprise one or more filters 818 and amplifiers 816. Radio front end circuitry 814 is connected to antenna 811 and processing circuitry 820, and is configured to condition signals communicated between antenna 811 and processing circuitry 820. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 810 components, such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments processing circuitry 820 of WD 810 may comprise a SOC. In some embodiments, RF transceiver circuitry 822, baseband processing circuitry 824, and application processing circuitry 826 may be on separate chips or sets of chips. In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc. and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices and circuits, and output interfaces, devices and circuits. User interface equipment 832 is configured to allow input of information into WD 810, and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices or power cells, may also be used. WD 810 may further comprise power circuitry 837 for delivering power from power source 836 to the various parts of WD 810 which need power from power source 836 to carry out any functionality described or indicated herein. Power circuitry 837 may in certain embodiments comprise power management circuitry. Power circuitry 837 may additionally or alternatively be operable to receive power from an external power source; in which case WD 810 may be connectable to the external power source (such as an electricity outlet) via input circuitry or an interface such as an electrical power cable. Power circuitry 837 may also in certain embodiments be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

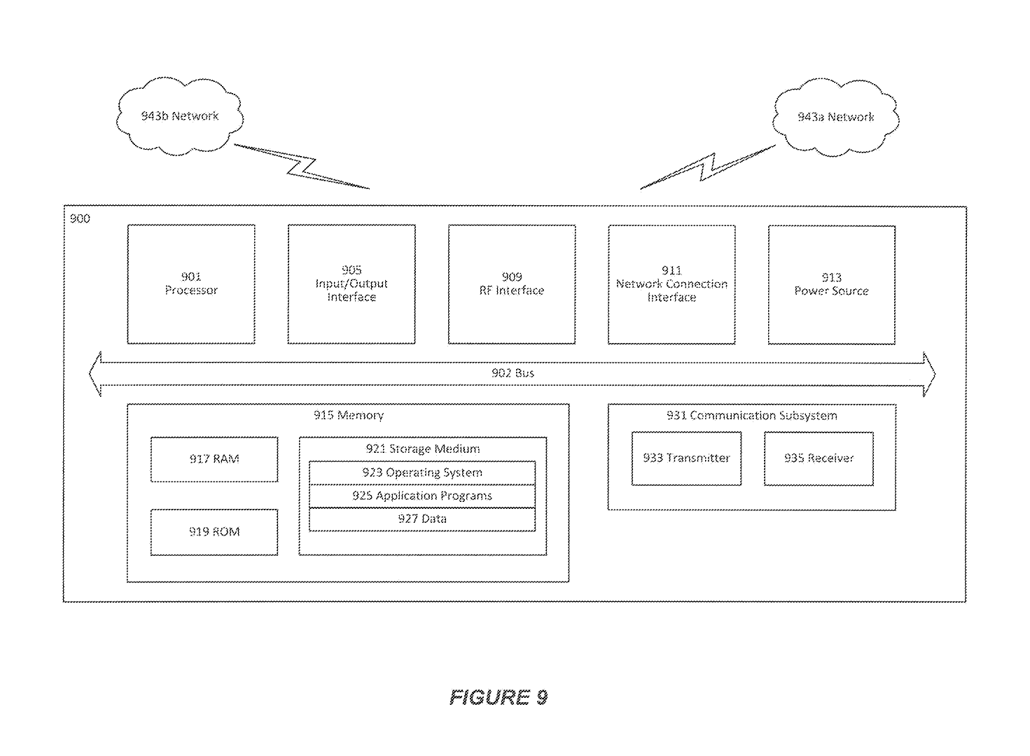

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 9200 may be any UE identified by the 3rd Generation Partnership Project (3GPP), including a NB-loT UE, a machine type communication (MTC) UE, and/or an enhanced MTC (eMTC) UE. UE 900, as illustrated in FIG. 9, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 900 includes processing circuitry 901 that is operatively coupled to input/output interface 905, radio frequency (RF) interface 909, network connection interface 911, memory 915 including random access memory (RAM) 917, read-only memory (ROM) 919, and storage medium 921 or the like, communication subsystem 931, power source 933, and/or any other component, or any combination thereof. Storage medium 921 includes operating system 923, application program 925, and data 927. In other embodiments, storage medium 921 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 901 may be configured to process computer instructions and data. Processing circuitry 901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 901 may include two central processing units (CPUs). Data may be information in a form suitable for use by a computer.

In the depicted embodiment, input/output interface 905 may be configured to provide a communication interface to an input device, output device, or input and output device. UE 900 may be configured to use an output device via input/output interface 905. An output device may use the same type of interface port as an input device. For example, a USB port may be used to provide input to and output from UE 900. The output device may be a speaker, a sound card, a video card, a display, a monitor, a printer, an actuator, an emitter, a smartcard, another output device, or any combination thereof. UE 900 may be configured to use an input device via input/output interface 905 to allow a user to capture information into UE 900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 909 may be configured to provide a communication interface to RF components such as a transmitter, a receiver, and an antenna. Network connection interface 911 may be configured to provide a communication interface to network 943a. Network 943a may encompass wired and/or wireless networks such as a local-area network (LAN), a wide-area network (WAN), a computer network, a wireless network, a telecommunications network, another like network or any combination thereof. For example, network 943a may comprise a Wi-Fi network. Network connection interface 911 may be configured to include a receiver and a transmitter interface used to communicate with one or more other devices over a communication network according to one or more communication protocols, such as Ethernet, TCP/IP, SONET, ATM, or the like. Network connection interface 911 may implement receiver and transmitter functionality appropriate to the communication network links (e.g., optical, electrical, and the like). The transmitter and receiver functions may share circuit components, software or firmware, or alternatively may be implemented separately.

RAM 917 may be configured to interface via bus 902 to processing circuitry 901 to provide storage or caching of data or computer instructions during the execution of software programs such as the operating system, application programs, and device drivers. ROM 919 may be configured to provide computer instructions or data to processing circuitry 901. For example, ROM 919 may be configured to store invariant low-level system code or data for basic system functions such as basic input and output (I/O), startup, or reception of keystrokes from a keyboard that are stored in a non-volatile memory. Storage medium 921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 921 may be configured to include operating system 923, application program 925 such as a web browser application, a widget or gadget engine or another application, and data file 927. Storage medium 921 may store, for use by UE 900, any of a variety of various operating systems or combinations of operating systems.

Storage medium 921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 921 may allow UE 900 to access computer-executable instructions, application programs or the like, stored on transitory or non-transitory memory media, to off-load data, or to upload data. An article of manufacture, such as one utilizing a communication system may be tangibly embodied in storage medium 921, which may comprise a device readable medium.

In FIG. 9, processing circuitry 901 may be configured to communicate with network 943b using communication subsystem 931. Network 943a and network 943b may be the same network or networks or different network or networks. Communication subsystem 931 may be configured to include one or more transceivers used to communicate with network 943b. For example, communication subsystem 931 may be configured to include one or more transceivers used to communicate with one or more remote transceivers of another device capable of wireless communication such as another WD, UE, or base station of a radio access network (RAN) according to one or more communication protocols, such as IEEE 802.9, CDMA, WCDMA, GSM, LTE, UTRAN, WiMax, or the like. Each transceiver may include transmitter 933 and/or receiver 935 to implement transmitter or receiver functionality, respectively, appropriate to the RAN links (e.g., frequency allocations and the like). Further, transmitter 933 and receiver 935 of each transceiver may share circuit components, software or firmware, or alternatively may be implemented separately.

In the illustrated embodiment, the communication functions of communication subsystem 931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 931 may include cellular communication, Wi-Fi communication, Bluetooth communication, and GPS communication. Network 943b may encompass wired and/or wireless networks such as a local-area network (LAN), a wide-area network (WAN), a computer network, a wireless network, a telecommunications network, another like network or any combination thereof. For example, network 943b may be a cellular network, a Wi-Fi network, and/or a near-field network. Power source 913 may be configured to provide alternating current (AC) or direct current (DC) power to components of UE 900.

The features, benefits and/or functions described herein may be implemented in one of the components of UE 900 or partitioned across multiple components of UE 900. Further, the features, benefits, and/or functions described herein may be implemented in any combination of hardware, software or firmware. In one example, communication subsystem 931 may be configured to include any of the components described herein. Further, processing circuitry 901 may be configured to communicate with any of such components over bus 902. In another example, any of such components may be represented by program instructions stored in memory that when executed by processing circuitry 901 perform the corresponding functions described herein. In another example, the functionality of any of such components may be partitioned between processing circuitry 901 and communication subsystem 931. In another example, the non-computationally intensive functions of any of such components may be implemented in software or firmware and the computationally intensive functions may be implemented in hardware.

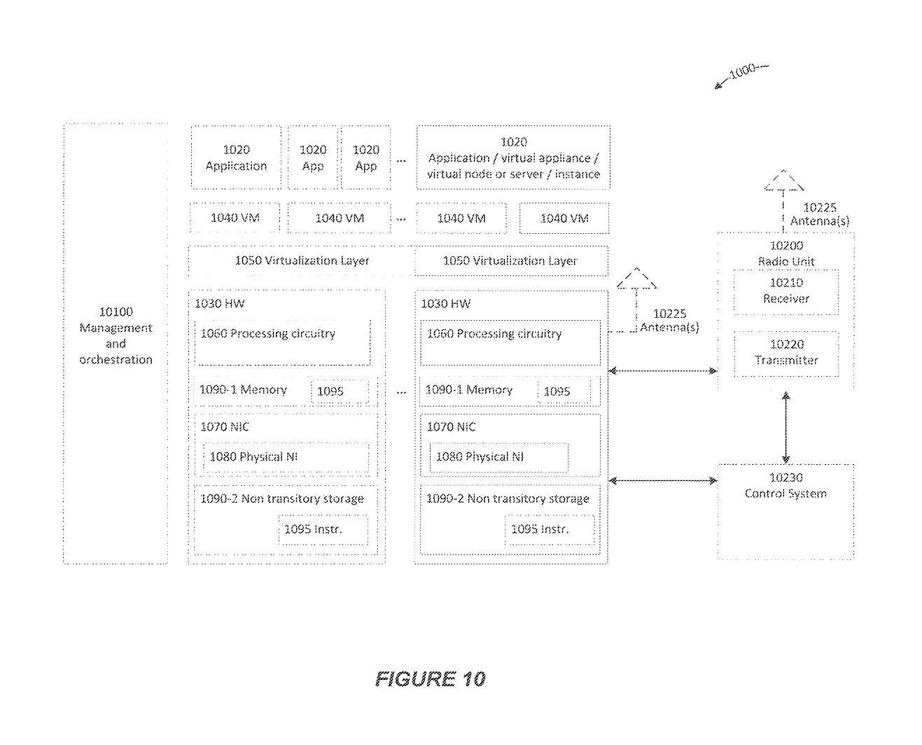

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030. Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000, comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features and/or benefits described in relation with some embodiments described herein.

Virtual machines 1040, comprise virtual processing, virtual memory, virtual networking or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g. such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1040 may be a software implementation of a physical machine that runs programs as if they were executing on a physical, non-virtualized machine. Each of virtual machines 1040, and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signalling can be effected with the use of control system 10230 which may alternatively be used for communication between the hardware nodes 1030 and radio units 10200.

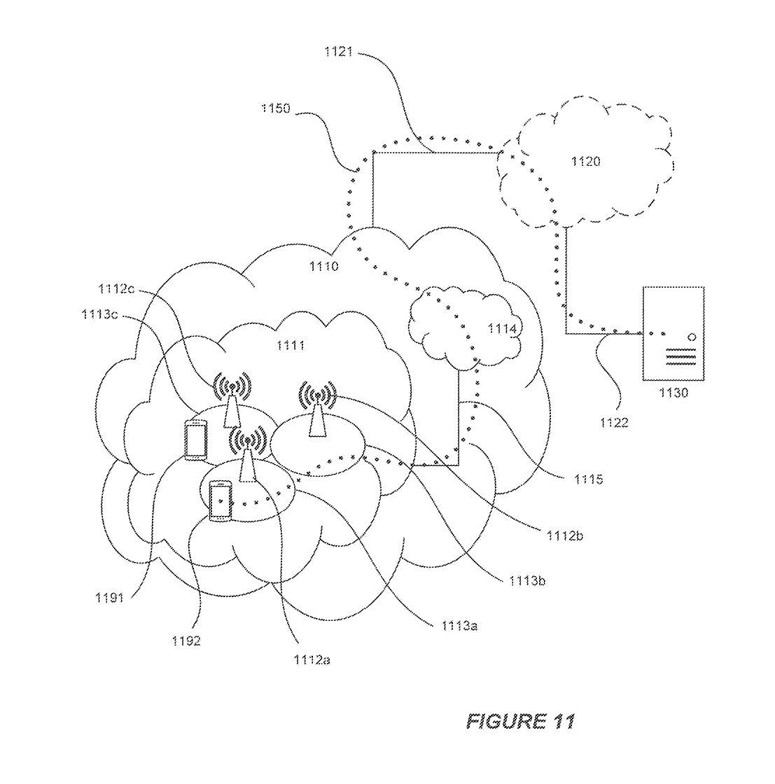

FIG. 11 illustrates a telecommunication network connected via an intermediate network to a host computer in accordance with some embodiments. In particular, with reference to FIG. 11, in accordance with an embodiment, a communication system includes telecommunication network 1110, such as a 3GPP-type cellular network, which comprises access network 1111, such as a radio access network, and core network 1114. Access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

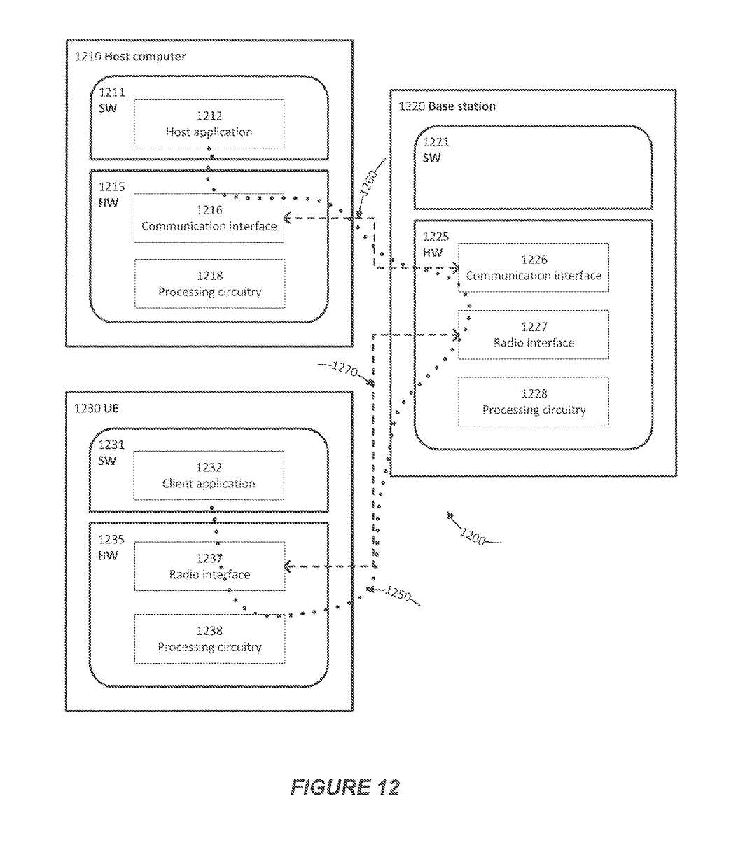

Example implementations, in accordance with an embodiment, of the UE, base station and host computer discussed in the preceding paragraphs will now be described with reference to FIG. 12. FIG. 12 illustrates host computer communicating via a base station with a user equipment over a partially wireless connection in accordance with some embodiments. In communication system 1200, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may improve the efficiency of communicating paging signaling parameters and thereby provide benefits such as providing for transmitting paging transmission parameter configurations when they have changed, but not increasing overhead by transmitting redundant paging transmission parameter configurations when the configurations have not changed from those broadcast for the purpose of RMSI transmission.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

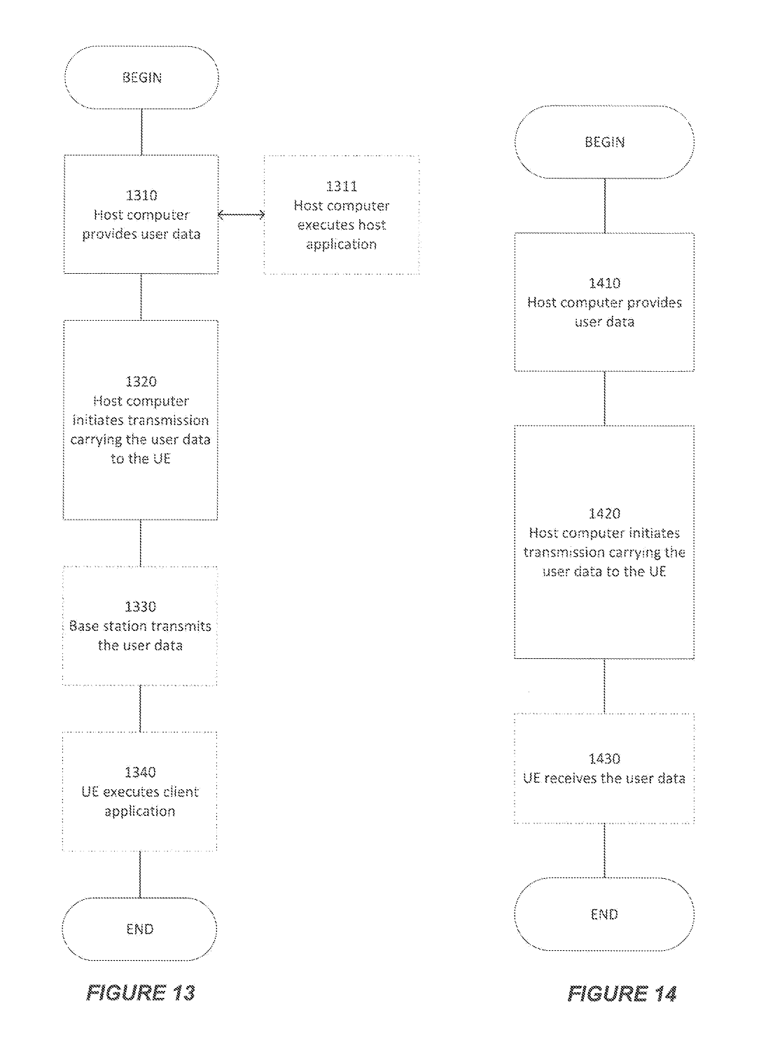

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

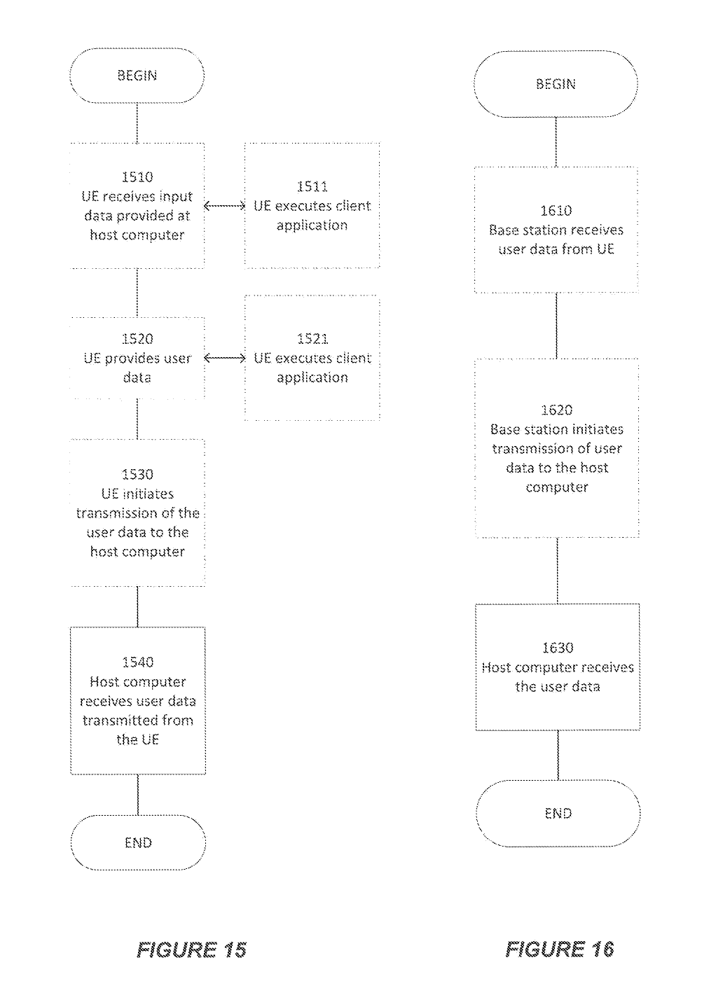

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

What is claimed is:

1. A method, performed by a wireless device, of adopting parameters for communication with a wireless communication network, the method comprising:
receiving information broadcast by a base station of the network;
obtaining, from the broadcast information, a Remaining Minimum System Information (RMSI) transmission parameter configuration;
receiving a RMSI transmission from the base station according to the RMSI transmission parameter configuration;
if a paging transmission parameter configuration is included in the received RMSI, adopting the paging transmission parameter configuration for paging reception; and
if the paging transmission parameter configuration is not included in the received RMSI, adopting the RMSI transmission parameter configuration for paging reception.

2. The method of claim 1, wherein the RMSI transmission parameter is a control resource set (CORESET) and/or an indication of numerology.

3. The method of claim 2, wherein the indication of numerology indicates a value of: subcarrier spacing, OFDM symbol length, and/or cyclic prefix length.

4. The method of claim 1, wherein the obtaining the RMSI transmission parameter configuration from the broadcast information comprises obtaining the configuration from a master information block (MIB).

5. The method of claim 1, wherein the receiving information broadcast by the base station comprises receiving the information on a physical broadcast channel (PBCH).

6. The method of claim 1, further comprising inspecting a first system information block (SIB1) in the RMSI for the paging transmission parameter configuration.

7. The method of claim 1, wherein the receiving the RMSI transmission from the base station comprises receiving the RMSI transmission on a physical downlink shared channel (PDSCH).

8. The method of claim 1, wherein the paging transmission parameter configuration is included in a first system information block (SIB1) of the RMSI.

9. The method of claim 1, further comprising, if the received RMSI does not include a paging transmission parameter configuration, retrieving a flag from the RMSI that explicitly indicates the RMSI transmission parameter configuration should also be used for paging signaling.

10. The method of claim 1, further comprising receiving paging signals from the base station according to the transmission parameter configuration adopted for paging reception.

11. The method of claim 1, further comprising:
providing user data; and
forwarding the user data to a host computer via a transmission to a base station.

12. A method, performed by a base station operative in a wireless communication network, of selectively transmitting paging configuration parameters, the method comprising:
determining a first configuration for a transmission parameter to be used for a Remaining Minimum System Information (RMSI) transmission;
broadcasting the first configuration for the transmission parameter;
determining a second configuration for the transmission parameter to be used for a paging transmission; and
if the second configuration differs from the first configuration:
including the second configuration in the RMSI; and
transmitting the RMSI including the second configuration.

13. The method of claim 12, wherein the transmission parameter is a control resource set (CORESET).

14. The method of claim 12, wherein the transmission parameter is an indication of numerology.

15. The method of claim 14, wherein the indication of numerology indicates the value of: subcarrier spacing, OFDM symbol length, and/or cyclic prefix length.

16. The method of claim 12, wherein the broadcasting the first configuration for the transmission parameter comprises including the first configuration in a master information block (MIB).

17. The method of claim 12, wherein the broadcasting the first configuration for the transmission parameter comprises broadcasting the first configuration on a physical broadcast channel (PBCH).

18. The method of claim 12, wherein the including the second configuration in the RMSI comprises including the second configuration in a first system information block (SIB1) in the RMSI.

19. The method of claim 12, wherein the transmitting the RMSI including the second configuration comprises transmitting the RMSI on a physical downlink shared channel (PDSCH).

20. The method of claim 12, further comprising, if the second configuration is the same as the first configuration, including a flag in the RMSI indicating that a wireless device should use the first configuration of the transmission parameter also for paging signaling.

21. The method of claim 12, further comprising paging a mobile device.

22. The method of claim 12, further comprising:
obtaining user data; and
forwarding the user data to a host computer or a wireless device.

23. A wireless device configured to adopt parameters for communication with a wireless communication network, the wireless device comprising:
processing circuitry;
memory containing instructions executable by the processing circuitry whereby the wireless device is operative to:
receive information broadcast by a base station of the network;
obtain, from the broadcast information, a Remaining Minimum System Information (RMSI) transmission parameter configuration;
receive a RMSI transmission from the base station according to the RMSI transmission parameter configuration;
if a paging transmission parameter configuration is included in the received RMSI, adopt the paging transmission parameter configuration for paging reception; and
if the paging transmission parameter configuration is not included in the received RMSI, adopt the RMSI transmission parameter configuration for paging reception.

24. The wireless device of claim 23, wherein the instructions are such that the wireless device is operative to inspect a first system information block (SIB1) in the RMSI for the paging transmission parameter configuration.

25. The wireless device of claim 23, wherein the paging transmission parameter configuration is included in a first system information block (SIB1) of the RMSI.

26. A base station configured to be operative in a wireless communication network, and adapted to selectively transmit paging configuration parameters, the base station comprising:
processing circuitry;
memory containing instructions executable by the processing circuitry whereby the base station is operative to:
determine a first configuration for a transmission parameter to be used for a Remaining Minimum System Information (RMSI) transmission;
broadcast the first configuration for the transmission parameter;
determine a second configuration for the transmission parameter to be used for a paging transmission; and
if the second configuration differs from the first configuration:
include the second configuration in the RMSI; and
transmit the RMSI including the second configuration.

27. The base station of claim 26, wherein the instructions are such that the base station is operative to broadcast the first configuration for the transmission parameter by including the first configuration in a master information block (MIB).

28. The base station of claim 26, wherein the instructions are such that the base station is operative to include the second configuration in the RMSI by including the second configuration in a first system information block (SIB1) in the RMSI.
